(19) United States
(12) Patent Application Publication
(10) Pub. No.: US 2014/0223354 A1
(43) Pub. Date: Aug. 7, 2014

(54) METHOD AND SYSTEM FOR CREATING FLOATING KEYS IN A PORTABLE DEVICE

(71) Applicant: Samsung Electronics Co., Ltd., Suwon-si (KR)

(72) Inventors: Barath Raj KANDUR RAJA, Karnataka (IN); Jith Thomas THELLEERATHU, Kerala (IN)

(73) Assignee: Samsung Electronics Co., Ltd., Suwon-si (KR)

(21) Appl. No.: 14/172,159

(22) Filed: Feb. 4, 2014

(30) Foreign Application Priority Data
Feb. 4, 2013 (IN) 491/CHE/2013

(51) Int. Cl. G06F 3/0484

(52) U.S. Cl. CPC G06F 3/0484
USPC 715/773

(57) ABSTRACT

A method and apparatus for creating floating keys in a portable device is provided. The method includes selecting a key by providing an activation signal on any of the keys present in a keypad of the device. Further, the selected key is floated to display irrespective of keypad layout, keypad type and input method engine. The floating keys can be created from any online document. The method also provides a Unicode interface to the user to add keys present in a web source as a floating key. Further, a method of creating floating keys with multiple key combinations is also disclosed.

### CROSS-REFERENCE TO RELATED APPLICATION(S)

This application claims the benefit under 35 U.S.C. §119(a) of an Indian patent application filed on Feb. 4, 2013 in the Indian Patent Office and assigned Serial No. 491/CHE/2013, the entire disclosure of which is hereby incorporated by reference.

### TECHNICAL FIELD

The present disclosure relates to an input method engine. More particularly, the present disclosure relates to a method and system for creation of floating keys, which are displayed irrespective of keypad layout, keypad type, and other input method engines.

### BACKGROUND

The modem communications era has brought about a tremendous expansion of wired and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of interactive applications in which the user may respond to a network device in order to perform a task or achieve a goal. In many situations, it may be desirable for the user to interface with a device such as a mobile terminal for the provision of an application or service. Furthermore, a user's experience during certain applications, such as web browsing or navigating through content, may be enhanced by using a touch screen display as the user interface.

Touch screen-enabled mobile terminals of the related art tend to be designed with key maps that are displayed on the screen to receive a user input without an additional input device, resulting in a light weight and a slim design. Typically, since the key maps of a portable terminal of the related art are designed according to a specific standard, it is required for the user to adapt to the standard and to use the key maps according to the standard. However, the use of such a key map-based portable terminal of the related art may result in an inconvenience to the user. For example, for inputting a character repeatedly or for inputting a specific character, the user must manipulate a key repetitively or otherwise make a specific input according to the rule of the standard, thus resulting in the user's inconvenience.

In a system of the related art, an optional key map may be provided to the user. This optional key map is linked to the basic or standard key map of the portable device or portable terminal and there exists a user interface to allow the registration of special characters with the optional key map. An optional key registration region is displayed at a region on the display unit of the portable device. The user can drag and drop the intended special character at a specific position in the optional key registration region. The optional key registration region can be formed as a single section or a set of multiple sections. Accordingly, the user can move the selected special character to one of the sections of the optional key registration region.

In the system of the related art described above, when the standard key map is changed, the user needs to register the keys accordingly for the new standard key map. Further, if the user uses a downloaded input method engine, then the optional key map cannot be attached. Furthermore, if the user uses a voice input engine, handwriting recognition, or any such method engines, it may cause an inconvenience to the user as these input method engines do not have any standard key map.

Accordingly, there exists a need for an improved method and system that provides better text input mechanisms.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system for creation of floating keys in a portable device.

Another aspect of the present disclosure is to provide a method and system for displaying floating keys on a screen of a portable device.

Another aspect of the present disclosure is to provide a method for a user to use floating keys when a keypad is not displayed in a portable device.

In accordance with an aspect of the present disclosure, a method for creating floating keys by a user of a portable device is provided. The method includes receiving an activation signal for selecting at least one key present in a keypad of said portable device. Further, the method floats the selected key to display on a screen of the portable device.

In accordance with another aspect of the present disclosure, an apparatus for creation of floating keys in a portable device is provided. The apparatus includes a user interaction module configured to receive an activation signal for selecting at least one key present in a keypad of the portable device. Further the apparatus includes a display module configured to float the selected key to display on a screen of the portable device.

In accordance with another aspect of the present disclosure, a non-transitory computer-readable storage medium is provided. The non-transitory computer-readable storage medium, when executed, causes at least one processor to receive an activation signal for selecting at least one key present in a keypad and to float the selected key to display on a screen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of a portable device according to an embodiment of the present disclosure;

FIG. 2 illustrates a portable device in which floating keys are created by a user according to an embodiment of the present disclosure;

FIG. 3 illustrates a portable device in which floating keys are created using multiple key combinations according to an embodiment of the present disclosure;

FIG. 4 illustrates creation of a floating key from a content source according to an embodiment of the present disclosure;

FIG. 5 illustrates a Unicode input interface for floating key creation according to an embodiment of the present disclosure;

FIG. 6 illustrates a portable device in which a plurality of floating keys created from multiple sources are displayed according to an embodiment of the present disclosure;

FIG. 7 illustrates a method for organizing floating keys in a portable device according to an embodiment of the present disclosure; and

FIG. 8 illustrates a computing environment implementing a method and system for creation of floating keys according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following embodiments of the present invention achieve a method and system for creation of floating keys in a portable device. The method comprises selecting a key by providing an activation signal on any of the keys present in the keypad of the device. Further, the selected key is floated to display irrespective of keypad layout (e.g., abc, 123, symbol keypads, etc.), keypad type (e.g., qwerty, 3×4 keypads, etc.) and input method engine (e.g., Swype, Go keyboard, Voice input engine, handwriting recognition, etc.). Even if the user changes the keypad layout, keypad type and input method engine, the floating key is visible on the screen of the portable device.

The floating key represents an interactive key. The floating key displays the corresponding characters on the screen of a portable device upon a user interaction.

In an embodiment, the portable device can be a mobile phone, a laptop, a tablet, or any electronic device, where an input for the device can be provided by using a stylus, a finger, or using any other hovering techniques.

In an embodiment, floating keys can be created from a web editor, web pages, or from any other content source apart from the keypad, displayed in the portable device.

In an embodiment, a floating key can be created by selecting multiple keys from the keypad of the device.

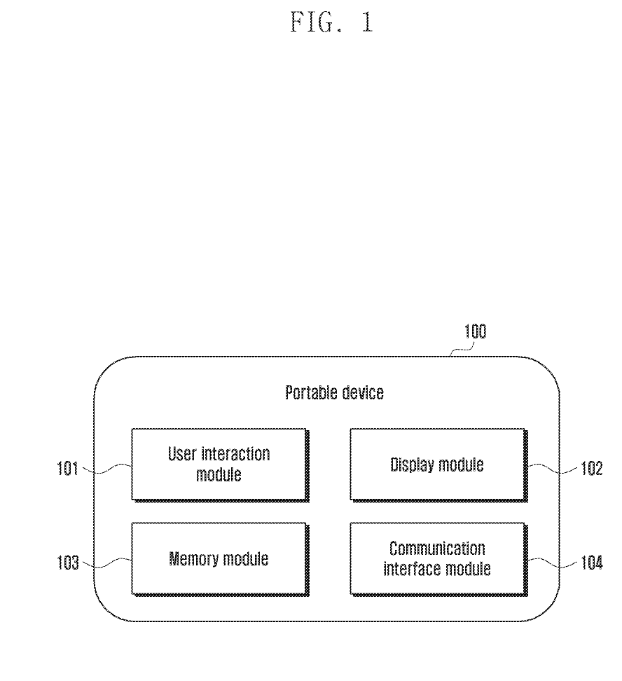

Referring now to the drawings, and more particularly to FIGS. 1 through 8, where similar reference characters denote corresponding features consistently throughout the figures, there are shown various embodiments of the present invention.

FIG. 1 illustrates a block diagram of a portable device according to an embodiment of the present disclosure.

Referring to FIG. 1, the portable device 100 comprises a user interaction module 101, a user interface module 102, a memory module 103 and a communication interface module 104. The user interaction module 101 provides the interactivity to the user. The user can interact with the portable device 100 by using a touch input, such as by using a stylus or a finger, or by using any other hovering techniques.

The display module 102 provides a user interface to the user for an input. In an embodiment, the display module 102 can be a touch screen.

The memory module 103 may include a Random Access Memory (RAM) or another type of dynamic storage device that may store information and instructions, for example an application, for execution by a processor, or may include a Read-Only Memory (ROM) device or another type of static storage device. The communication interface module 104 may include any transceiver like mechanism that enables the portable device 100 to communicate with other devices or systems.

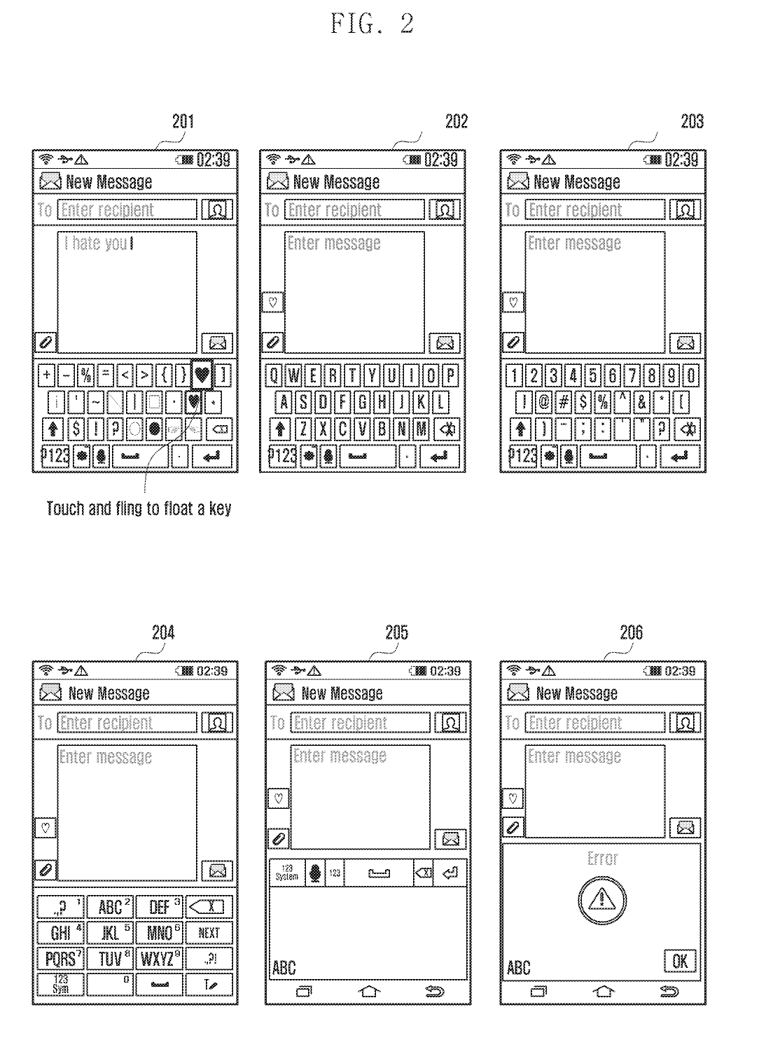

FIG. 2 illustrates a portable device in which floating keys are created by a user according to an embodiment of the present disclosure.

Referring to FIG. 2, the method of creation of floating key comprises providing an activation signal for the keys that are displayed in the keypad of the portable device 100. The activation signal can be provided by performing certain actions, which include a touch, a fling, or any other gesture based event on a selected key of the keypad in the portable device 100.

In an embodiment, the activation signal for creating a floating key can be provided by using a finger, or can be provided by using other stylus hovering techniques.

Initially, a user selects a key from a keypad of the portable device 100 by providing an activation signal. The key selected by the user acts as a floating key. That is, the floating key is displayed to the user on the screen of the portable device 100 irrespective of the keypad layout, keypad type, and the input method engine.

As shown in 201, an activation signal may be provided for a Heart key. Because the heart key is a floating key, it is displayed irrespective of keypad layouts, keypad types, input method engines, or any other screen. For example, in 202 (i.e., abc layout) and 203 (i.e., 123 layout), it is illustrated that the floating key can be displayed irrespective of keypad layouts. Further, the floating key can be displayed irrespective of keypad types as shown in 204 (i.e., 3×4 keypad type). The floating key can also be displayed irrespective of input method engines as shown in 205 (i.e., Handwriting Engine) and 206 (i.e., Voice input engine). It is to be understood that the heart key is merely an example of a key that may be designated as a floating key and, as will be described below, any key may be a floating key.

The method identifies whether the user has to enter text. If it is identified that the user has to enter text, the floating key will be displayed on the screen, regardless of whether the keypad is present.

The floating key can be moved, dragged, resized, reshaped, re-colored or otherwise variously configured anywhere in the screen as required or desired by the user.

In an embodiment, the floating key can be docked to a particular keypad layout or keypad type or an input method engine.

An input method engine represents a program that allows any data, such as keyboard strokes or mouse movements, to be received as input. With an input method engine, users can enter characters and symbols not found on their input devices.

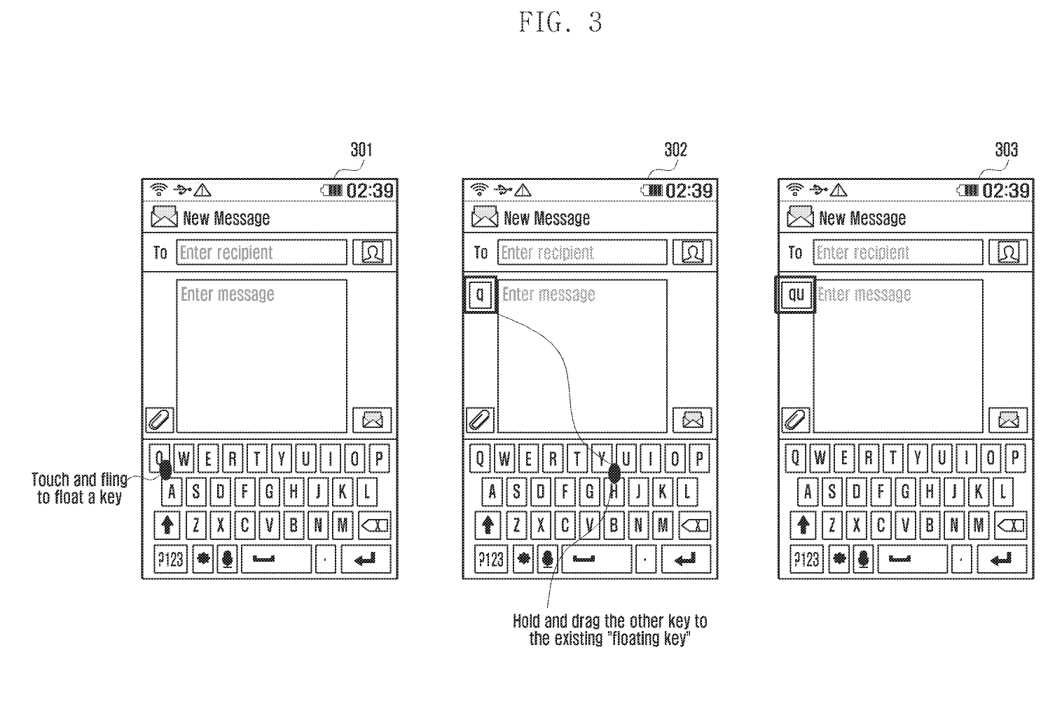

FIG. 3 illustrates a portable device in which floating keys are created using multiple key combinations according to an embodiment of the present disclosure.

Referring to FIG. 3, initially an activation signal is provided for the character ‘q’ as depicted in 301. By providing the activation signal to the ‘q’, a floating key with character ‘q’ is created. Once the floating key with character ‘q’ is created, the activation signal is provided for the other character in the keypad (e.g., ‘u’). Further, the character ‘u’ is dragged to the existing floating key ‘q’ for combining the floating keys, as shown in 302. Hence, a combined floating key ‘qu’ with multiple key combinations ‘q’ and ‘u’ is created as shown in 303.

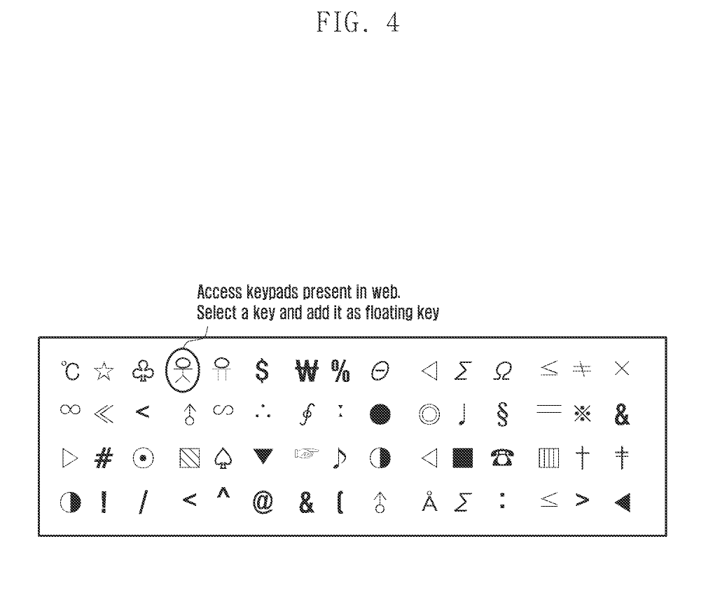

FIG. 4 illustrates creation of a floating key from a content source according to an embodiment of the present disclosure.

Referring to FIG. 4, the floating key can be created by accessing the keypad, present in online documents.

In the example of FIG. 4, the online documents include but are not limited to a webpage, a web source, or any other content source.

In an embodiment, an interface is provided to the user for adding the keys present in the online documents as a floating key.

When a particular key is selected from the web source, the Unicode for the selected key can be identified. Whenever there is an event on the floating key created through the online documents, corresponding Unicode can be mapped. The Unicode is a computing industry standard for the consistent encoding, representation, and handling of text. The Unicode provides a unique number for every character.

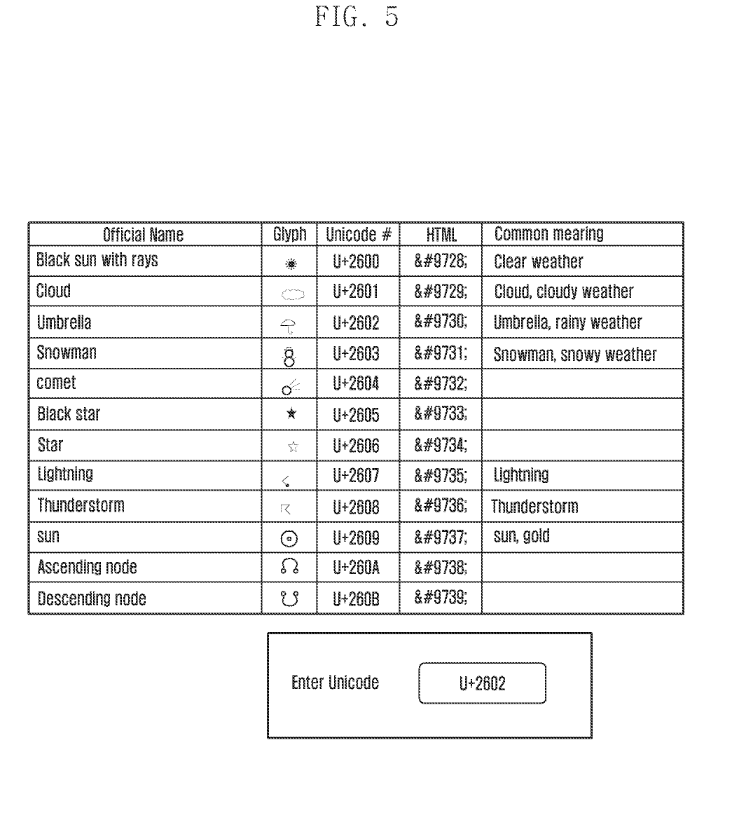

FIG. 5 illustrates a Unicode input interface for floating key creation according to an embodiment of the present disclosure.

Referring to FIG. 5, an input interface can be provided to the user to enter the Unicode. The character corresponding to the entered Unicode is added as a floating key. As depicted in FIG. 5, the Unicode value U+2602 is entered by the user in the Unicode interface. When the user enters the Unicode value (U+2602), an umbrella symbol as shown in the table is added as a floating key to the portable device of the user.

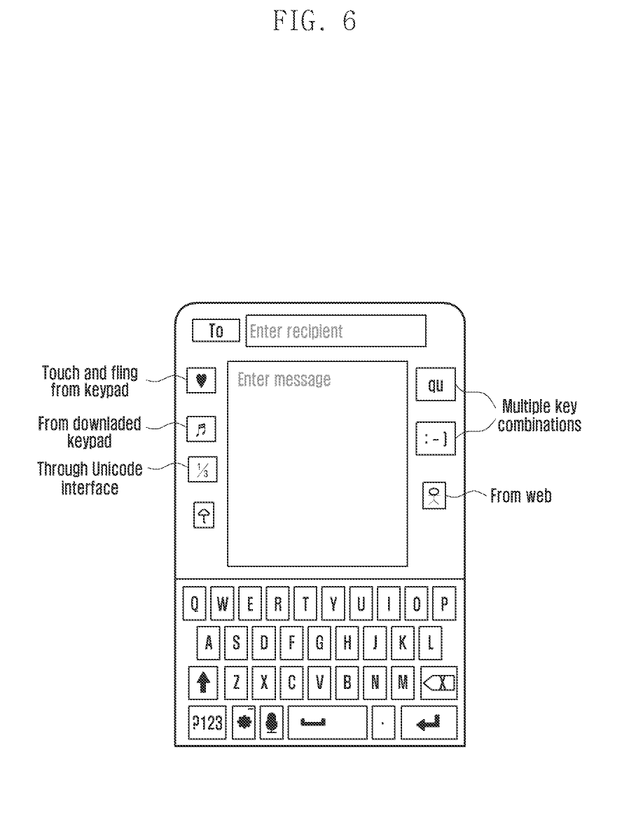

FIG. 6 illustrates a portable device in which a plurality of floating keys created from multiple sources are displayed according to an embodiment of the present disclosure.

Referring to FIG. 6, the floating keys can be created and displayed to the user on the screen of the portable device 100. The figure shows the creation of floating keys by providing activation signals from different keypad layouts. A floating key can be created by a touch and fling from the keypad of the portable device 100 as shown in FIG. 6. The floating key (with a music note and a fraction (⅓)) is created from the downloaded keypads and can be displayed to the user.

Further, using the Unicode input interface, a floating key (with an umbrella symbol) is created and displayed to the user as shown in FIG. 6. From a web source, a floating key is created and displayed on the screen to the user irrespective of the keypad layout, keypad type, and the input method engine. Also, the floating key with multiple key combinations (namely ‘qu’ and the smiley symbol) can be created and displayed to the user. The floating keys created in the portable device 100 can be shared with another device, which can be a mobile phone, a laptop, a tablet, or the like.

In an embodiment, the floating key may be shared with another device using data transfer protocols such as Bluetooth, Near Field Communication (NFC), Wi-Fi Direct, or the like.

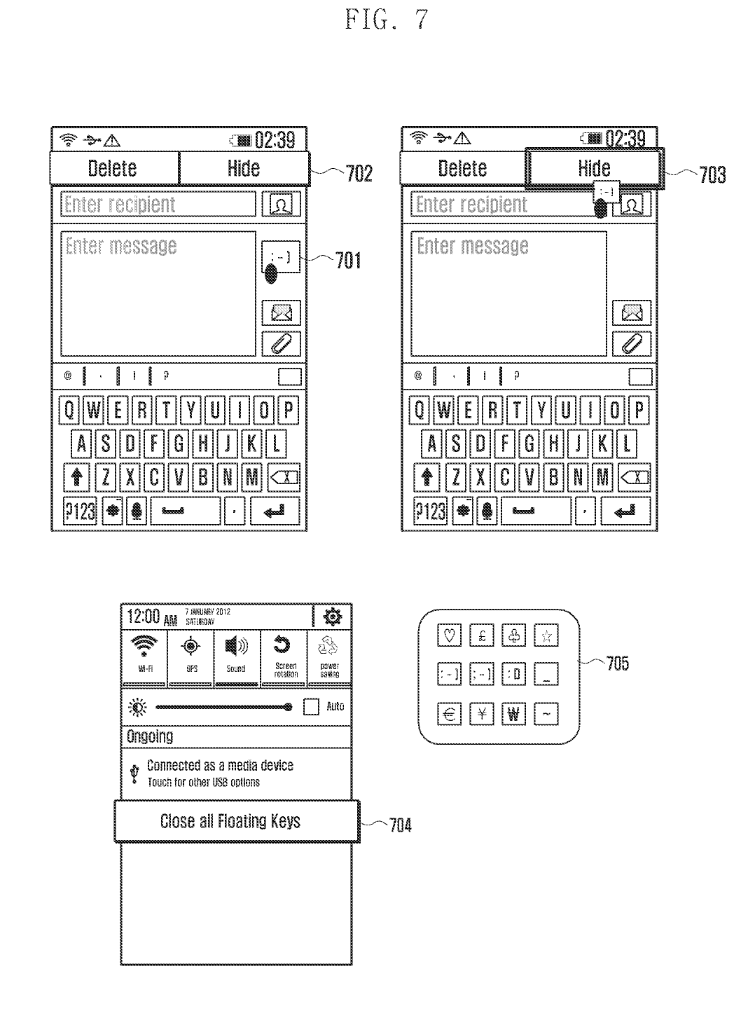

FIG. 7 illustrates a method for organizing floating keys in a portable device according to an embodiment of the present disclosure.

Referring to FIG. 7, the floating keys are created and displayed to the user on the screen of the portable device 100. The floating key 701 (i.e., a smiley symbol) is created by the user. When the user drags the floating key 701, a menu option 702 can be displayed. In the example of FIG. 7, the menu option 702 and delete and hide function options are provided on top of the screen. However, this is only an example and it should be understood that the location of the menu and function options as well as which specific function options are provided may vary. When the user drags the floating key 701 on the menu option, the corresponding menu option is focused as shown in 703. Further, when the user releases or drops the floating key on the menu option, a corresponding action is performed, whether to delete or hide the floating key 701.

Further, a notification 704 is displayed to the user for closing all the floating keys that are present on the screen of the portable device 100, as shown in FIG. 7. When the user clicks on the notification 704, all the active floating keys displayed in the screen are closed.

In an embodiment, the floating keys may be moved, resized, reshaped, re-colored, and docked on the screen of the portable device 100 device in order to organize the floating keys.

Further, some additional settings can be provided for the floating keys, such as to make them active or inactive (hidden). For example, all the active and hidden floating keys may be displayed, as shown in 705, and tapping on them can toggle from active to hidden state. Also, a floating key can be made inactive from a hidden state based on its current state.

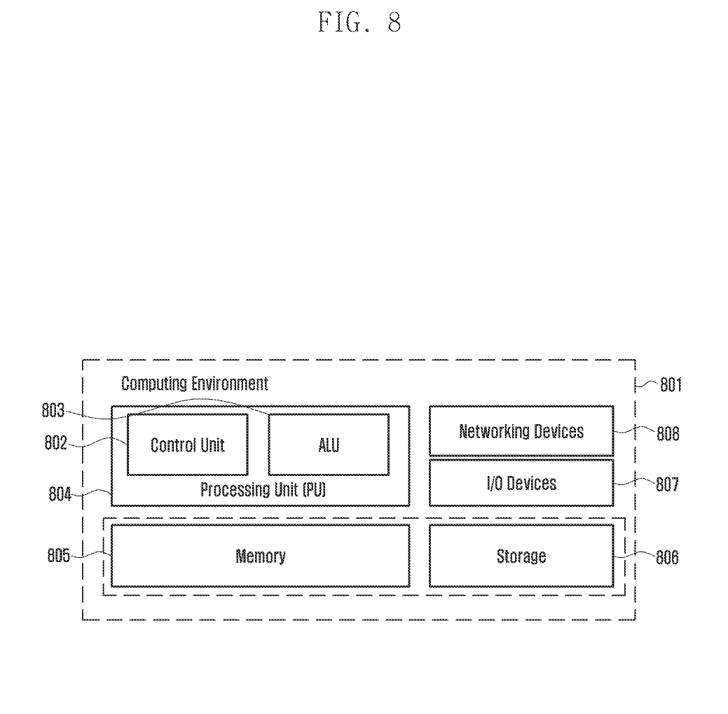

FIG. 8 illustrates a computing environment implementing a method and system for creation of floating keys according to an embodiment of the present disclosure.

Referring to FIG. 8, the computing environment 801 comprises at least one processing unit 804 that is equipped with a control unit 802 and an Arithmetic Logic Unit (ALU) 803, a memory 805, a storage unit 806, a plurality of networking devices 808, and a plurality of Input Output (I/O) devices 807. The processing unit 804 is responsible for processing the instructions of the algorithm. The processing unit 804 receives commands from the control unit 802 in order to perform its processing. Further, any logical and arithmetic operations involved in the execution of the instructions are computed with the help of the ALU 803.

The overall computing environment 801 can be composed of multiple homogeneous and/or heterogeneous cores, multiple CPUs of different kinds, special media, and other accelerators. The processing unit 804 is responsible for processing the instructions of the algorithm. Further, the plurality of processing units 804 may be located on a single chip or over multiple chips.

The algorithm comprising of instructions and codes required for the implementation are stored in either the memory unit 805 or the storage 806 or both. At the time of execution, the instructions may be fetched from the corresponding memory 805 and/or storage 806, and executed by the processing unit 804.

In case of any hardware implementations, various networking devices 808 or external I/O devices 807 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 and 8 include blocks which can be at least one of a hardware device, or a combination of hardware device and software module.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for creating floating keys in a portable device, the method comprising:
receiving an activation signal for selecting at least one key present in a keypad of the portable device; and
floating the selected key to display on a screen of the portable device.

2. The method of claim 1, further comprising:
selecting at least one key from an online document;
identifying a Unicode for the key selected from the online document;
detecting a character that corresponds to the Unicode; and
adding the detected character as a floating key.

3. The method of claim 2, further comprising:
selecting multiple keys from the online document and;
adding the selected multiple keys from the online document for the floating key.

4. The method of claim 2, further comprising providing a user interface for entering the Unicode of the character by the user.

5. The method of claim 1, further comprising organizing the floating key by at least one of moving, dragging, resizing, reshaping, re-coloring, and docking the floating key.

6. The method of claim 5, further comprising at least one of deleting and hiding the floating key.

7. The method of claim 1, further comprising sharing the floating key with another device.

8. The method of claim 1, wherein the activation signal comprises at least one of a touch, a fling, and a drag.

9. The method of claim 1, further comprising receiving a selection to enter text, wherein the floating of the selected key to display on the screen is performed after the receiving of the selection to enter text.

10. An apparatus for creation of floating keys in a portable device, the apparatus comprising:
a user interaction module configured to receive an activation signal for selecting at least one key present in a keypad of the portable device; and
a display module configured to float the selected key to display on a screen of the portable device.

11. The apparatus of claim 10, wherein the user interaction module is further configured to:
select at least one key from online documents;
identify a Unicode for the key selected from the online documents;
detect a character that corresponds to the Unicode; and
add the detected character as a floating key.

12. The apparatus of claim 11, wherein the user interaction module is further configured to select multiple keys from the online document, and to add the selected multiple keys from the online document for the floating key.

13. The apparatus of claim 11, wherein the user interaction module is further configured provide a user interface for entering the Unicode of the character by the user.

14. The apparatus of claim 10, wherein the user interaction module is further configured to organize the floating key by at least one of moving, dragging, resizing, reshaping, re-coloring, and docking the floating key.

15. The apparatus of claim 14, wherein the user interaction module is further configured to at least one of delete and hide the floating key.

16. The apparatus of claim 14, wherein the user interaction module is further configured to share the floating key with another device.

17. The apparatus of claim 10, wherein the activation signal comprises at least one of a touch, a fling, and a drag.

18. The apparatus of claim 10, wherein the user interaction module is further configured to receive a selection to enter text, wherein the floating of the selected key to display on the screen is performed after the receiving of the selection to enter text.

19. A non-transitory computer-readable storage medium storing a program that, when executed, causes at least one processor to perform the method of claim 1.
